(19) United States
(12) Patent Application Publication
(10) Pub. No.: US 2026/0233852 A1
(43) Pub. Date: Aug. 13, 2026

(54) Multistage Free-Flight Testing System

(71) Applicant: United States of America as represented by the Administrator of NASA, Washington, DC (US)

(72) Inventors: Cole D. KAZEMBA, San Jose, CA (US); Benjamin J. LIBBEN, San Jose, CA (US); Hannah S. ALPERT, Sunnyvale, CA (US)

(21) Appl. No.: 19/308,207

(22) Filed: Aug. 23, 2025

Related U.S. Application Data
(60) Provisional application No. 63/686,729, filed on Aug. 23, 2024.

(51) Int. Cl. B64D 45/00; B64B 1/40; B64C 30/00; B64D 1/02; B64G 1/66

(52) U.S. Cl. CPC B64D 45/00; B64B 1/40; B64C 30/00; B64D 1/02; B64G 1/66; B64D 2045/0085

(57) ABSTRACT

A multistage flight system for assessing performance of atmospheric flight systems in high-speed, flight-similar conditions includes a drop platform mountable to a lifting device for lifting the drop platform to a target altitude. The drop platform includes a frame supporting one or more payloads, a release mechanism operable to release the one or more payloads from the frame, and platform avionics operable to receive a drop signal and trigger the release mechanism. The system further includes one or more projectiles supported by the frame as the one or more payloads and each including an aerodynamic body with a ballast section at a lower end, a plurality of fins at an upper end, an avionics section within the aerodynamic body housing projectile avionics operable to trigger release of a test article stored within the projectile, and an ejection mechanism operable to eject the test article from the projectile.

### CROSS-REFERENCE TO RELATED APPLICATIONS

This application claims the benefit of U.S. Provisional Patent Application No. 63/686,729, filed Aug. 23, 2024, which is hereby incorporated by reference as if fully set forth herein.

### ORIGIN OF INVENTION

The invention described herein was made by employees of the United States Government and may be manufactured and used by or for the Government of the United States of America for governmental purposes without the payment of any royalties thereon or therefor.

### FIELD OF THE INVENTION

The present disclosure relates generally to flight vehicle testing and, more particularly, to a multistage system for testing supersonic free-flight behavior of flight vehicles.

### BACKGROUND

During atmospheric entry of a blunt-body vehicle, such as a crew capsule or planetary probe, travel through the supersonic and transonic regimes can impart divergent and possibly catastrophic instabilities to the flight of the vehicle. The passage of these blunt-body vehicles through the supersonic and transonic regimes can represent one of the most significant mission risks for reentry operations. The dynamic stability of the vehicle, and introduced instabilities, can be driven primarily by interactions between wake and vehicle shape in a complex, non-linear relationship; however, the fundamental understanding of these dynamic stability problems is still lacking. Linearized motion equations, basic design heuristics, and reaction control systems have been utilized in place of this fundamental understanding to mitigate mission risks, but these approaches often fail to provide high-confidence results. As such, advances in blunt-body vehicle designs have been limited while stable, conventional vehicle shapes have been re-used to limit risks.

Several experimental and simulation methodologies currently exist in order to understand the dynamic stability issues in blunt-body vehicles. Experimental physical setups that include ballistic ranges, free-and forced-oscillation wind tunnels, and vertical spin tunnels can be employed to obtain aerodynamic results for various flight conditions. However, each of these experimental set-ups includes at least one drawback (e.g., wind tunnel stings altering wake profiles) that can prevent matching flight conditions or retrieving quality data. Furthermore, these experimental testing apparatuses are limited in number and availability, such that rapid and continued testing of various blunt-body vehicles is unrealistic. While simulation or computational methods are being developed for studying dynamic stability during reentry, these computational methods cannot be confidently utilized without extensive validation using quality experimental data. Further methods of testing and obtaining quality data, such as full-scale flight tests, can be complex, time-consuming, and prohibitively expensive, particularly during the design stage of these blunt-body vehicles.

Accordingly, systems and methods for obtaining experimental data of flight vehicles in flight-similar conditions are desirable for obtaining rich measurements in a repeatable, controlled manner.

### SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a multistage flight system for assessing performance of atmospheric flight systems in high-speed, flight-similar conditions includes a drop platform mountable to a lifting device for lifting the drop platform to a target altitude. The drop platform includes a frame sized and shaped to receive one or more payloads, a release mechanism operable to release the one or more payloads from the frame, and platform avionics operable to receive a drop signal and trigger the release mechanism. The system further includes one or more projectiles supported by the frame as the one or more payloads, the one or more projectiles each including an aerodynamic body including a ballast section at a lower end thereof and a plurality of fins at an upper end, an avionics section within the aerodynamic body housing projectile avionics operable to trigger release of a test article stored within the projectile, and an ejection mechanism within the aerodynamic body operable to eject the test article from the projectile when triggered by the projectile avionics.

In another embodiment, a method of assessing the flight performance of a test vehicle includes lifting a drop platform to a desired altitude using a lifting device, the drop platform including a plurality of projectile bays and platform avionics, initiating release of each projectile from each projectile bay at a pre-defined interval upon receiving a drop signal from the lifting device, accelerating a dropped projectile to supersonic, transonic, or subsonic speeds, the dropped projectile housing the test vehicle, ejecting the test vehicle from the dropped projectile using an ejection mechanism of the dropped projectile upon reaching a desired Mach number, a desired target altitude, or a combination thereof, and collecting data for the test vehicle using a plurality of sensors within the test vehicle during deceleration, descent, and landing of the test vehicle.

In a further embodiment, a projectile for accelerating a test article to a desired test condition includes an aerodynamic body defining a ballast section at a lower end thereof and a plurality of fins at an upper end, an avionics section within the aerodynamic body and housing projectile avionics operable to trigger release of the test article from the projectile upon reaching the desired test condition, a test article section housing the test article within the aerodynamic body, and an ejection mechanism within the aerodynamic body, the ejection mechanism operable to eject the test article from the projectile when triggered by the projectile avionics.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 illustrates an example operation of a multistage flight system for obtaining experimental data of a vehicle in flight-similar conditions, according to one or more embodiments of the present disclosure.

FIG. 2A is a schematic isometric view of a drop platform for housing and lifting a plurality of projectiles, according to one or more embodiments of the present disclosure.

FIG. 2B is a schematic bottom view of the drop platform, according to one or more embodiments of the present disclosure

FIG. 2C is a schematic view of a trapdoor hot wire cutter for use on the drop platform of FIG. 2A, according to one or more embodiments of the present disclosure.

FIG. 3A is a schematic side view of a projectile deployable from the drop platform of FIG. 2A, according to one or more embodiments of the present disclosure.

FIG. 3B illustrates a side view of a vehicle section of the projectile deployable from the drop platform of FIG. 2A including a test vehicle housed within, according to one or more embodiments of the present disclosure.

FIG. 3C is a bottom schematic view of an underside of a stationary plate showing additional components of an ejection mechanism of the projectile, according to one or more embodiments of the present disclosure.

FIG. 4 is a schematic side view of a test vehicle housed within and ejectable from the projectile of FIG. 3A, according to one or more embodiments of the present disclosure.

FIG. 5 illustrates an example method for testing the dynamic stability of a test vehicle in flight-similar conditions, according to one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to flight vehicle testing and, more particularly, to a multistage system for testing supersonic free-flight behavior of flight vehicles. The embodiments disclosed herein provide an architecture for free-flight dynamic stability testing of one or more test vehicles through supersonic and transonic Mach numbers. The disclosed systems and methods can include a multistage flight system operable to accelerate a test vehicle to supersonic conditions prior to release and data gathering. The disclosed systems can include a first stage drop platform for housing a plurality of projectiles that can be time-released after the drop platform has reached a desired altitude. In the disclosed embodiments, each projectile stored within the drop platform can house a test vehicle and an ejection mechanism operable to eject the test vehicle into free flight upon reaching a desired velocity or altitude. The disclosed methods and systems can further include an avionics package within each test vehicle operable to collect and store flight data during free flight.

The disclosed embodiments can provide flight-similar conditions for each test vehicle to enable the acquisition of rich, dynamically-scaled data during flight. The disclosed drop platform can enable the simultaneous testing of a plurality of test vehicles, each housed within a respective ballistic projectile, thus enabling the testing of design variations and the statistical understanding of vehicle behavior. The disclosed embodiments can provide a low-cost, tailorable testing capability that can provide testing coverage for the most critical Mach number regimes, which are conventionally the most difficult regimes to test. The components of the disclosed embodiments can be constructed using additive manufacturing and low-cost materials, such that both cost and weight are minimized for testing operations. Through the use of the multistage flight system disclosed herein, dynamic stability data can be captured for a plurality of test vehicles under flight-similar conditions to enable efficient and robust reentry vehicle design, testing, and simulation.

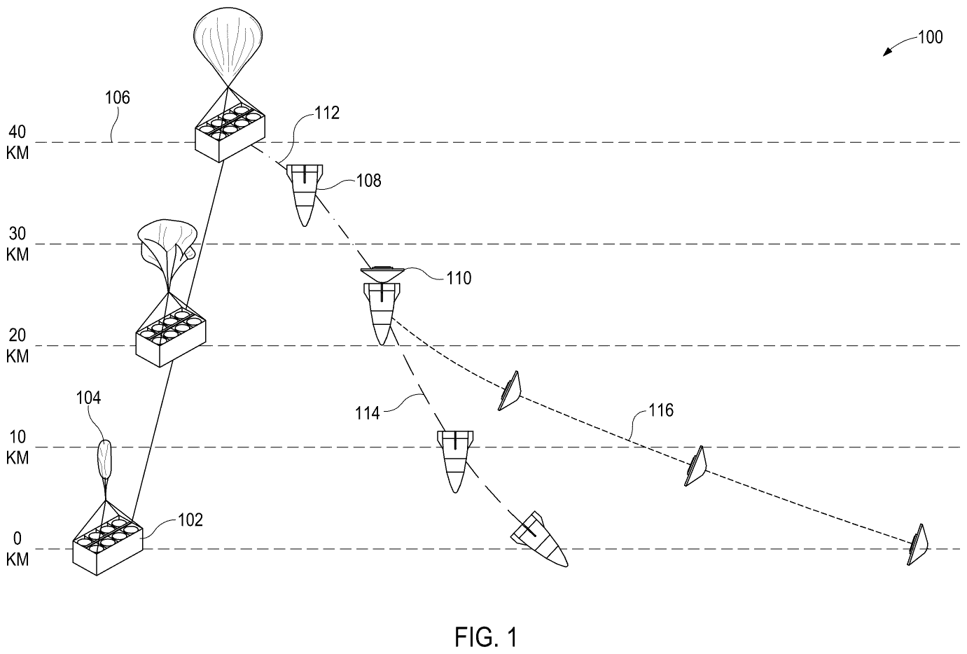

FIG. 1 illustrates an example operation of a multistage flight system 100 for testing dynamic stability in flight-similar conditions, according to one or more embodiments of the present disclosure. Multistage flight system 100 can include three distinct stages to enable data collection in flight-similar conditions. A first stage of multistage flight system 100 can include a drop platform 102 providing a robust, thermally-stable housing for the further stages. Drop platform 102 may be mountable to a lifting device, such as a stratospheric balloon 104, to raise drop platform 102 to a target altitude 106. In some embodiments, in which the lifting device is a stratospheric balloon 104, target altitude 106 can be about 40 kilometers above sea level to enable sufficient altitude for a projectile 108 to accelerate to the desired Mach and altitude conditions for testing of the further stages of multistage flight system 100.

Drop platform 102 can include a plurality of projectiles 108 housed therein, representing a second stage of multistage flight system 100, and can be configured to release each projectile 108 at a pre-defined interval once at target altitude 106. In some embodiments, the pre-defined interval can be about 30 seconds between dropping each projectile 108, such that a first projectile 108 does not interfere with flight of a second projectile 108. Each projectile 108 can be dropped from target altitude 106 and can accelerate towards the Earth. Projectiles 108 can be aerodynamically shaped to enable each projectile 108 to reach supersonic speeds during acceleration.

Each projectile 108 can include a test vehicle 110 housed therein, representing a third stage of multistage flight system 100, and can be configured to eject test vehicle 110 from projectile 108 upon reaching a target flight condition, such as velocity, altitude, or Mach number (e.g., Mach 1.35-1.7 or 23-27 kilometers above sea level). Prior to ejection, projectile 108 and test vehicle 110 can travel in a combined trajectory 112 away from drop platform 102. Once the target altitude or Mach number has been reached by projectile 108, test vehicle 110 can be launched from an upper end of projectile 108 and into the atmosphere at supersonic speeds. After launching of test vehicle 110 from projectile 108, projectile 108 can continue with a projectile trajectory 114 until landing on the Earth's surface.

In contrast, test vehicle 110 can continue with a vehicle trajectory 116 as test vehicle 110 decelerates through the supersonic and transonic regimes until reaching terminal velocity. During this deceleration and landing, test vehicle 110 can record flight and vehicle state data using on-board sensors to assess dynamic stability performance. Upon landing, test vehicle 110 can transmit a landing location to an operator, such that test vehicle 110 can be retrieved and data can be extracted therefrom. As such, test vehicle 110 can capture rich flight data in flight-similar conditions for the most critical Mach regimes, in which data collection is conventionally the most difficult. The use of multiple projectiles 108 within drop platform 102 can enable the testing of multiple test vehicles 110 during a single flight. In some embodiments, each test vehicle 110 can be the same design, such that statistical analysis can further improve the obtained data. In further embodiments, however, each test vehicle 110 can include a unique design, such that various designs can be tested and compared in a single flight with the same atmospheric conditions.

Multistage flight system 100 can be designed using low-cost materials, such that a full multistage flight system 100 can cost about tens-to-hundreds of thousands of dollars for a setup with eight projectiles 108 and eight test vehicles 110. In contrast, conventional systems capable of capturing similar flight data, such as sounding rockets and full-sized test vehicles, can cost millions of dollars for a single test, while wind tunnel and ballistic range testing can cost hundreds of thousands to millions of dollars. Furthermore, as discussed further below, multistage flight system 100 can be easily tailored for different test vehicles 110, launch angles, Mach numbers, and target altitudes 106. As such, while the disclosed embodiments are discussed for obtaining dynamic stability data, a person having ordinary skill in the art will appreciate that multistage flight system 100 can be utilized in collecting any high-speed testing data within the atmosphere. As such, multistage flight system 100 can be further applicable for fluid dynamics, parachute or other decelerator systems, propulsion systems, and defense applications without departing from the scope of the present disclosure. Further, multistage flight system 100 can be utilized not to replace ballistic ranges or wind tunnels, but rather to serve as a complementary capability which can fill the gap (regarding Mach number) and can serve as a flight-like validation for these ground tests and for CFD predictions.

Multistage flight system 100 can be further tailored to meet scaling requirements for any active mission through the alteration of mass properties and altitude of separation between projectile 108 and test vehicle 110. Furthermore, this scaling can be matched across each regime of interest, such that the Mach scaling is within 20% for the supersonic and transonic regimes, while the Froude scaling is within 20% for the Mach 0.4 to terminal velocity regime, thus exceeding the capabilities of any available ambient ballistic range testing. Multistage flight system 100 can accordingly provide the most flight-like conditions to obtain rich, dynamically-scaled data for multiple test vehicles 110 in a single flight, while being low-cost and extensively tailorable to the desired full-scale mission of interest.

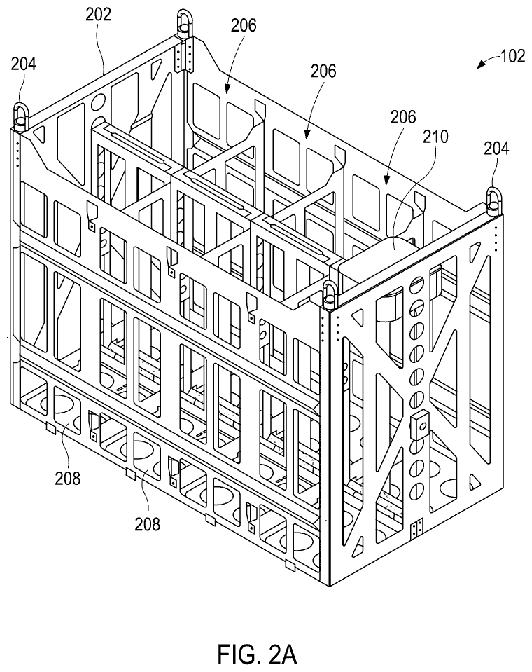

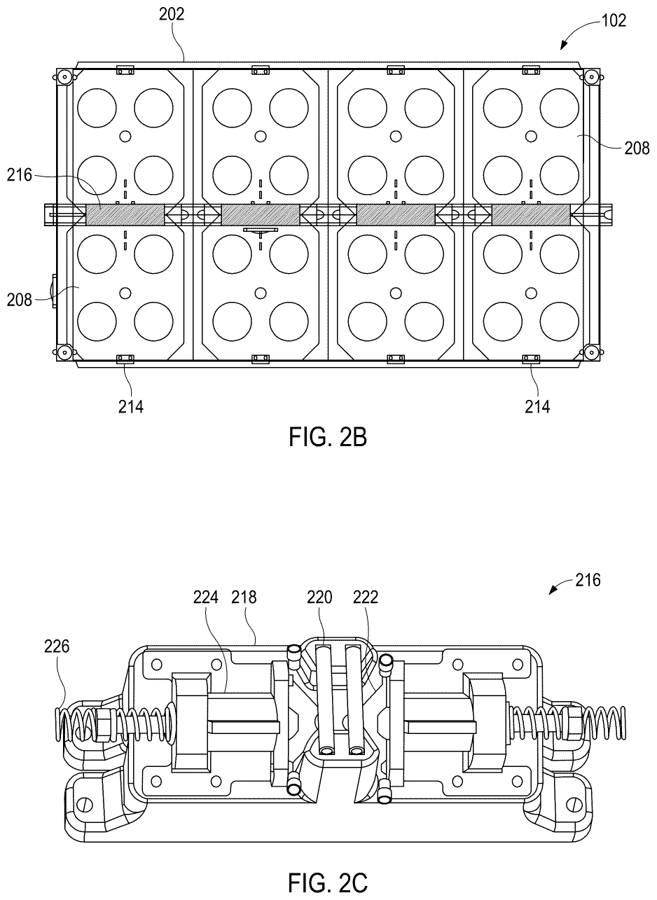

FIG. 2A is a schematic isometric view of drop platform 102 for housing and lifting a plurality of projectiles 108 of FIG. 1, according to one or more embodiments of the present disclosure. As discussed above, drop platform 102 can provide a robust, thermally-stable housing for the projectiles 108 and test vehicles 110 of FIG. 1. Drop platform 102 can accordingly include a frame 202 defining a structure of drop platform 102, which can be constructed of a light-weight sheet metal to maintain mechanical stability while maximizing payload weights stored therein. In further embodiments, however, frame 202 can be formed of any light-weight, durable material, without departing from the scope of the present disclosure. As shown, a plurality of various apertures and openings can be provided around frame 202 to further limit weight while maintaining the structural integrity of frame 202. Thus, one skilled in the art will appreciate that any outer structure can be modified or omitted, such that frame 202 can be constructed of a plurality of L-, T-, and U-beams to retain projectiles 208 therein. Frame 202 can include a plurality of hard points 204 for mounting drop platform 102 to a lifting device (e.g., to stratospheric balloon 104) to lift drop platform 102 to target altitude 106 of FIG. 1. In the illustrated embodiment, frame 202 includes four hard points 204, with one hard point 204 on each corner of frame 202. In further embodiments, however, any number of hard points 204 can be provided on frame 202 without departing from the scope of the present disclosure.

Frame 202 can be constructed such that a plurality of projectile bays 206 are defined within an interior of frame 202. Each projectile bay 206 can be sized and shaped to receive a payload therein, such as projectile 108 of FIG. 1, for storage and deployment. In the illustrated embodiment, frame 202 defines eight distinct projectile bays 206 to enable the launching of eight projectiles 108 in a single flight. Each projectile bay 206 can include a release mechanism to release the payload from drop platform 102, such as a trapdoor 208 in the illustrated embodiment. In these embodiments, each projectile bay 206 includes a trapdoor 208 installed at a lower end thereof that can retain a projectile 108 within projectile bay 206 until a drop signal is received.

To manage opening of each trapdoor 208, as well as to receive and transmit commands from the lifting device, drop platform 102 can include platform avionics 210 mounted to frame 202. Platform avionics 210 can include at least a microcontroller and one or more power sources, and can be communicatively coupled with the lifting device and each trapdoor 208. As drop platform 102 is intended for use in atmospheric temperatures as low as −60° C. in some embodiments, drop platform 102 can include a plurality of heaters distributed around frame 202 and/or within platform avionics 210 to provide closed-loop thermal control. In some embodiments, heaters can be coupled to radiator plates (not shown) operable to distribute heater energy around frame 202 or within platform avionics 210. Platform avionics 210 can be coupled to heaters to provide the closed-loop control to prevent thermal damage to sensors and batteries of drop platform 102 and multistage flight system 100. In some embodiments, drop platform 102 can be further covered with a Mylar blanket prior to launch in order to further limit thermal or radiative effects on the sensitive components of multistage flight system 100.

Referring now to FIG. 2B, a schematic bottom view of the drop platform 102 and trapdoors 208 is illustrated according to one or more embodiments of the present disclosure. In the illustrated embodiment, each trapdoor 208 is shown as being mounted to frame 202 via a friction hinge 214 around an outer perimeter of frame 202. Friction hinges 214 can be used to secure each trapdoor 208 to frame 202, while preventing bounceback of trapdoor 208 towards projectile 108 after opening. In some embodiments, each trapdoor 208 can be designed to bend under the load from projectile 108 in a manner that creates tension such that trapdoor 208 can swing open and away from projectile bays 206 upon opening.

To maintain each trapdoor 208 in a closed position during ascent, a trapdoor hot wire cutter mechanism 216 can secure each trapdoor 208 using a retention cord that can pass therethrough. Trapdoor hot wire cutter mechanism 216 can maintain tension in the retention cord to hold each trapdoor 208 closed until receiving a signal from platform avionics 210, relayed from the lifting device, to open each trapdoor 208. Upon receiving the signal, each trapdoor hot wire cutter mechanism 216 can be activated to sever the retention cord and enable trapdoor 208 to swing open and away from projectile bays 206. In further embodiments, however, the retention cord can hold a locking pin and tension spring system in place to secure each trapdoor 208. In these embodiments, trapdoor hot wire cutter mechanism 216 can cut the retention cord and enable a pin to be retracted under the spring, releasing all the load of each trapdoor 208 and projectile 108. One having skill in the art will appreciate that any other release mechanisms can be provided for each trapdoor 208 without departing from the scope of the present disclosure.

Once trapdoor 208 is swung open by the applied pre-tension or the weight of a projectile 108 of FIG. 1, friction hinge 214 can maintain trapdoor 208 in the open position to allow the projectile 108 to drop from drop platform 102. Platform avionics 210 can then pause activation of further trapdoor hot wire cutter mechanism 216 until a pre-defined interval has passed (e.g., about 30 seconds) before signaling a further trapdoor hot wire cutter mechanism 216 to open a further trapdoor 208. This process can continue for each trapdoor 208 until all projectiles 108 are deployed from drop platform 102, at which point the lifting device can be deactivated to return drop platform 102 to the surface.

FIG. 2C is a schematic view of a trapdoor hot wire cutter mechanism 216 for use on drop platform 102, according to one or more embodiments of the present disclosure. In the illustrated embodiment, trapdoor hot wire cutter mechanism 216 includes a cutter body 218 that houses two distinct hot wire cutters operable to sever distinct retention cords. Each retention cord can be formed of high-strength fibers, such as liquid-crystal polymer fibers (e.g., VECTRAN™). As shown in the embodiment of FIG. 2B, each trapdoor hot wire cutter mechanism 216 can interpose two trapdoors 208 (one above and one below), and the single cutter body 218 can enable the cutting of both trapdoors 208 independently.

As discussed above, trapdoor hot wire cutter mechanism 216 can receive a retention cord over each dowel pin 220 positioned centrally within cutter body 218. Each dowel pin 220 can provide an anchoring point for holding each trapdoor 208 closed, such that each dowel pin 220 directly carries the load of each trapdoor 208. Each hot wire cutter of trapdoor hot wire cutter mechanism 216 can include an independent wire 222 to be heated via one or more batteries of the platform avionics 210 upon receiving a signal to open a trapdoor 208. In some embodiments, each trapdoor hot wire cutter mechanism 216 is not activated unless a constant signal is received from the lifting device for three seconds, thus limiting accidental release and providing an abort window. In these embodiments, energy can be dumped from each battery into the trapdoor hot wire cutter mechanisms 216 sequentially at a specified interval to open each trapdoor 208. Each battery can provide a current into wire 222 to provide resistive heating therethrough and begin melting and severing the retention cord. In some embodiments, wire 222 can be a Ni-Chrome (nickel and chromium) wire due to the high electrical resistivity and high melting point. Wire 222 can abut the retention cord after tensioning, such that wire 222 can begin melting and severing the retention cord when signaled.

In some embodiments, each trapdoor hot wire cutter mechanism 216 can include a safety clip 224 near the wire 222. In these embodiments, safety clip 224 can be operable to disengage wire 222 from the retention cord, thus disarming the trapdoor hot wire cutter mechanism 216. Upon removal of safety clip 224, wire 222 can be forced into contact with the retention cord to enable melting and severing upon receiving energy from the batteries. To aid in severing the retention cord, each hot wire cutter of trapdoor hot wire cutter mechanism 216 can be mechanically energized via a tension spring 226. After receiving the retention cord under tension, wire 222 can be tensioned against the retention cord by removing safety clip 224 such that tension spring 226 can be extended. As such, each hot wire cutter of trapdoor hot wire cutter mechanism 216 can be suspended in tension between the retention cord and tension spring 226. As wire 222 heats and begins to sever the retention cord, energy of the tension spring 226 can pull wire 222 further into the retention cord to ensure the retention cord is successfully severed. After severing the retention cord, wire 222 can translate towards tension spring 226 as it is returned to an untensioned state. With the retention cord severed, a corresponding trapdoor 208 can swing and remain open to drop a projectile 108 of FIG. 1 from drop platform 102.

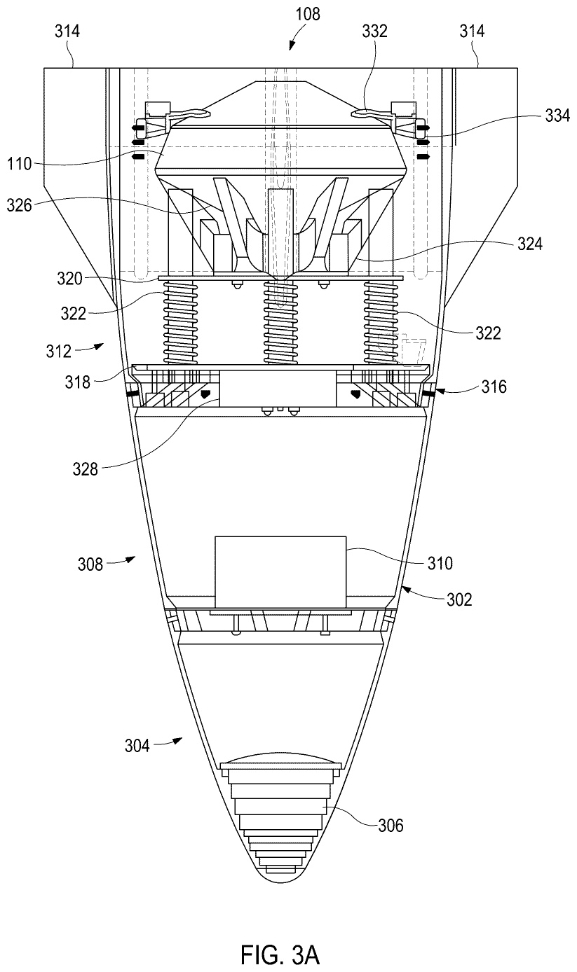

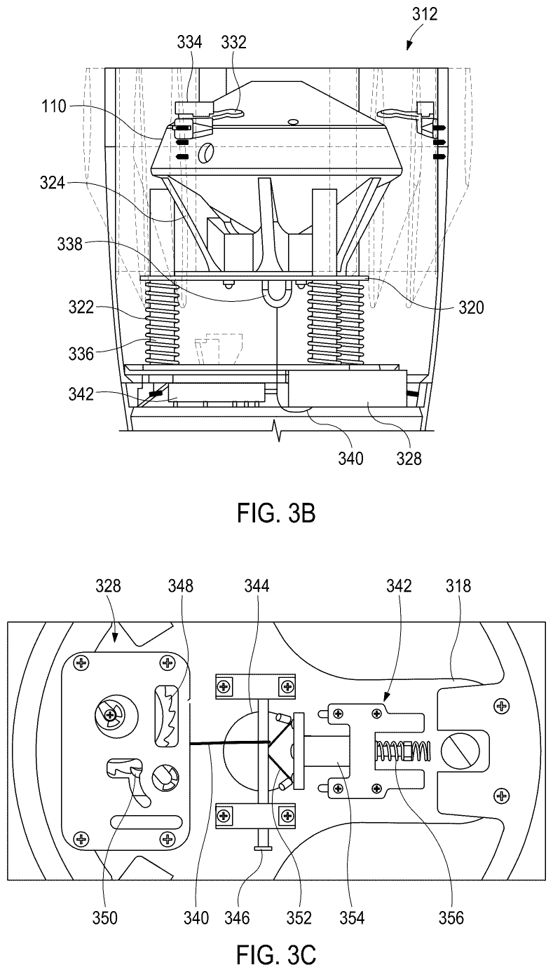

FIG. 3A is a schematic side view of a projectile 108 deployable from drop platform 102 of FIG. 2A, according to one or more embodiments of the present disclosure. Projectile 108 can be seen to include three distinct sections within an aerodynamic projectile body 302. In some embodiments, projectile body 302 can be additively manufactured to enable low-cost, low-weight, rapidly-manufacturable, and tunable designs for projectile 108. A first, ballast section 304 is provided at a lower end of projectile body 302, and can be aerodynamically shaped to include a nose or tip following a tapered outer mold line. Ballast section 304 can primarily house ballast 306 within the nose to ensure a low center of mass and provide the desired acceleration of projectile 108 during the drop. In some embodiments, ballast 306 can be about 3 kilograms of steel positioned within the ballast section 304 to provide acceleration up to about Mach 1.7.

Projectile body 302 can further include an avionics section 308 above ballast section 304 and housing projectile avionics 310. Projectile avionics 310 can include a microcontroller, one or more heaters, one or more sensors, and one or more power sources. During operation, projectile avionics 310 can monitor conditions of projectile 108 in flight to determine atmospheric conditions, altitude, and speed. While release of projectile 108 from drop platform 102 of FIG. 2A was controlled by platform avionics 210, release of test vehicle 110 from projectile 108 can be controlled by projectile avionics 310 stored in avionics section 308. Upon determining that projectile 108 has reached the desired altitude for test vehicle 110, projectile avionics 310 can trigger ejection of test vehicle 110 from a third, test article section, referred to hereafter as vehicle section 312.

Vehicle section 312 can be positioned at an upper end of projectile body 302 and can primarily house test vehicle 110 therein prior to release into the freestream. Vehicle section 312 can include a plurality of fins 314 radially arranged about projectile body 302, each fin 314 operable to maintain aerodynamic stability during the drop and acceleration of projectile 108. Within vehicle section 312, projectile 108 can include both test vehicle 110 and an ejection mechanism 316 operable to launch test vehicle 110 into the freestream upon actuation. In further embodiments, however, ejection mechanism 316 can be installed within avionics section 308, while interfacing with vehicle section 312 and the test vehicle 110, without departing from the scope of the present disclosure. Ejection mechanism 316 can be actuated upon receiving a signal from projectile avionics 310 that the desired conditions have been met for launch.

Ejection mechanism 316 can be primarily formed of a stationary surface 318 and a travelling plate 320 interposed by one or more compression springs 322. Stationary surface 318 can be fixably mounted at a bottom of vehicle section 312 within projectile 108, and each compression spring 322 can be mounted to stationary plate 318. The opposing end of each compression spring 322 can be mounted to travelling plate 320 above stationary surface 318 within vehicle section 312, and travelling plate 320 can be free to travel vertically therein based on motion of compression springs 322. To retain and launch test vehicle 110, a support claw 324 can be fixably mounted to a top of travelling plate 320. Support claw 324 can include a number of vertical protrusions, or fingers, configured to cradle an exterior surface of test vehicle 110 thereon. In some embodiments, support claw 324 can define a support surface 326 across the vertical protrusions, such that support surface 326 is complementary in shape to a bottom surface of test vehicle 110. As such, test vehicle 110 can be located and received on support surface 326 to enable maximized transfer of mechanical energy from compression springs 322 to test vehicle 110 during launch. While the illustrated embodiment includes three compression springs 322 arranged between the traveling plate 320 and stationary surface 318, it will be appreciated that any energized ejection mechanism (e.g., a spring-loaded piston) can be utilized to launch the test vehicle 110 without departing from the scope of the present disclosure.

To tension and maintain compression of compression springs 322, a self-locking gear mechanism can be provided on an underside of stationary plate 318. In the illustrated embodiment, the self-locking gear mechanism is ratcheting gear mechanism 328; however, in further embodiments the self-locking gear mechanism can include any other mechanism to tension and maintain compression of compression springs 322, such as a worm-drive/worm-wheel system. Ratcheting gear mechanism 328 can be configured to receive and spool a retention cord 340 (FIG. 3B) to pull travelling plate 320 down towards stationary plate 318. Ratcheting gear mechanism 328 can be designed to enable tensioning retention cord 340 without enabling slip in the reverse, unspooling direction. While compression springs 322 are compressed within projectile 108, one or more retention tabs 332 can extend from an interior of vehicle section 312 and engage with test vehicle 110. Retention tabs 332 can prevent lateral or vertical motion of test vehicle 110 within vehicle section 312 prior to reaching the desired ejection conditions. Upon triggering of ejection mechanism 316, however, retention tabs 332 can be pivoted away from test vehicle 110 via friction hinges 334 to prevent interference between retention tab 332 and test vehicle 110 as test vehicle 110 exits projectile 108. In further embodiments, however, friction hinges 334 can be replaced with standard hinges or other pivoting mechanisms to be driven away by motion of ejection mechanism 316.

FIG. 3B illustrates a side view of vehicle section 312 of projectile 108 deployable from the drop platform 102 of FIG. 2A, according to one or more embodiments of the present disclosure. In the illustrated embodiment, projectile 108 is shown angularly rotated to provide an alternate view of ejection mechanism 316 and subcomponents thereof. As shown, each compression spring 322 of ejection mechanism 316 can include at least a concentric guide post 336 operable to prevent lateral play of each compression spring 322 during compression and extension. Each guide post 336 can limit tipoff of test vehicle 110 from projectile 108 during launch, such that test vehicle 110 can enter the freestream without an undesired perturbation from the desired initial test conditions. Each guide post 336 can axially-constrain translation of traveling plate 320 by slotting within a corresponding aperture (not shown) on the traveling plate 320, and a guide post retention clamp (not shown) can be included on a top of each guide post 336. Guide posts 336 can accordingly constrain deformation of compression springs 322 based upon the limited motion of guide post 336 within each corresponding aperture, while the guide post retention clamps further provide a mechanical stop at a top of travel to stop further motion of traveling plate 320 and to enable launching of test vehicle 110 therefrom. In further embodiments, however, guide posts 336 and support claw 324 can be adjusted or manufactured to enable lateral sway or to achieve a specified launch angle, without departing from the scope of the present disclosure.

Further, in the alternate view of ejection mechanism 316, a retention hook 338 is shown protruding from a bottom surface of travelling plate 320. Retention hook 338 can provide an attachment point for a retention cord 340 to be affixed thereto, such that retention cord 340 can pull down on travelling plate 320 to compress compression springs 322. In some embodiments, retention cord 340 can be formed of high-strength fibers, such as liquid-crystal polymer fibers (e.g., VECTRAN™), in order to maintain compression of compression springs 322 without premature failure. Retention cord 340 can be run through a central aperture (central aperture 344 of FIG. 3C) defined through stationary plate 318, and can be inserted into ratcheting gear mechanism 328 on the underside of stationary plate 318. Ratcheting gear mechanism 328 can be utilized to tension the retention cord 340 in the winding direction, while preventing slip, such that ratcheting gear mechanism 328 can enable compression of compression springs 322 to a desired level for launching test vehicle 110.

As retention cord 340 is run to ratcheting gear mechanism 328, an ejection hot wire cutter 342 can be arranged against the tensioned retention cord 340. Ejection hot wire cutter 342 can be similarly mounted to an underside of stationary plate 318, and can operate in a similar manner to trapdoor hot wire cutter mechanism 216 of FIG. 2C, as will be discussed further in FIG. 3C below. Upon severing of retention cord 340 by ejection hot wire cutter 342, stored energy in compression springs 322 can be released and transferred to travelling plate 320. Travelling plate 320 can ascend vertically until reaching one or more hard stops (not shown), at which point motion of travelling plate 320 is arrested while test vehicle 110 continues axially and out of vehicle section 312. During this ejection, retention tabs 332 can be displaced and pivoted out of the path of test vehicle 110 and retained out of the path via friction hinges 334.

FIG. 3C is a bottom schematic view of an underside of stationary plate 318 showing additional components of ejection mechanism 316, according to one or more embodiments of the present disclosure. The underside of stationary plate 318 clearly depicts central aperture 344 defined through stationary plate 318, and further depicts passage of retention cord 340 therethrough. As retention cord 340 penetrates through stationary plate 318, retention cord 340 can be routed over clevis 346 to provide a transitional surface between vertical and horizontal travel. Retention cord 340 can pass over clevis 346 and into ratcheting gear mechanism 328, as discussed above. As further discussed above, in further embodiments, ratcheting gear mechanism 328 can be any self-locking gear mechanism operable to tension and maintain compression of compression springs 322, such as a worm-drive/worm-wheel system.

Within ratcheting gear mechanism 328, retention cord 340 can be received around spoke gear 348, which can define a cord groove to house and retain retention cord 340 therein. Spoke gear 348 can be accordingly turned clockwise, in the illustrated embodiment, to increase tension of retention cord 340 and compress compression springs 322 of FIG. 3A-3B. After turning, a pawl 350 can prevent slip in the reverse direction to maintain tension within retention cord 340. In some embodiments, pawl 350 can be energized via a torsion spring to resist motion away from spoke gear 348. In some embodiments, ratcheting gear mechanism 328, spoke gear 348, and pawl 350 can be additively-manufactured in order to enable a custom design and dimensions for tensioning retention cord 340, as desired.

As discussed above, a wire 352 of ejection hot wire cutter 342 can be positioned against retention cord 340 after tensioning. Wire 352 can be a Ni-Chrome (nickel and chromium) wire due to the high electrical resistivity and high melting point, and can be powered by one or more batteries housed in projectile avionics 310 after receiving a release signal from the microcontroller in projectile avionics 310. As with trapdoor hot wire cutter mechanism 216 of FIG. 2C, ejection hot wire cutter 342 can be energized via a tension spring 356 to pull against tensioned retention cord 340 and ensure contact between wire 352 and retention cord 340. Accordingly, upon receiving the release signal from projectile avionics 310, wire 352 can be heated via batteries housed in projectile avionics 310 to begin melting and severing retention cord 340. As wire 352 cuts through retention cord 340, tension spring 356 can maintain contact therebetween and can dig wire 352 further into retention cord 340 to ensure a clean cut and release of travelling plate 320. In some embodiments, each ejection hot wire cutter 342 can include a safety clip 354 near the wire 352. In these embodiments, safety clip 354 can be operable to disengage wire 352 from retention cord 340, thus disarming the ejection hot wire cutter 342. Upon removal of safety clip 354, wire 352 can be forced into contact with the retention cord 340 to enable melting and severing upon receiving energy from the batteries.

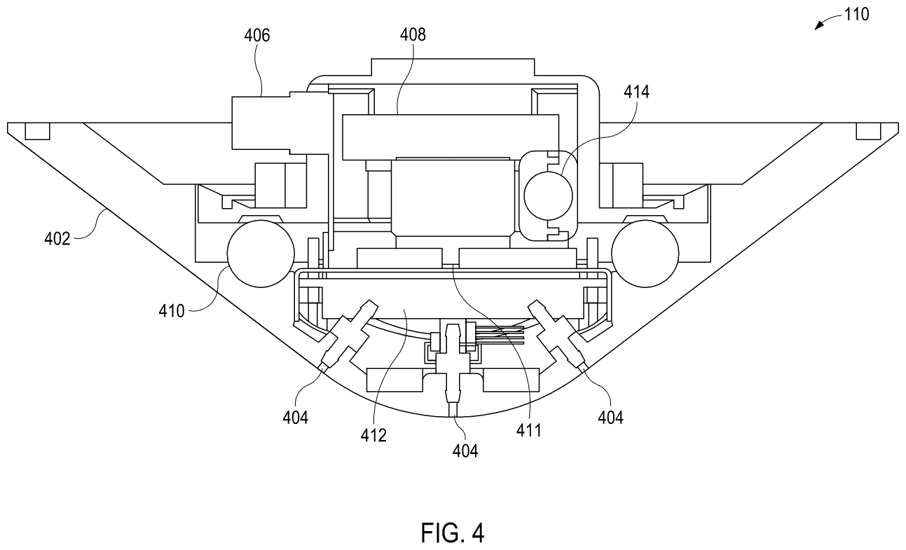

FIG. 4 is a schematic side view of a test vehicle 110 configured to be housed within and ejectable from projectile 108 of FIG. 3A, according to one or more embodiments of the present disclosure. It should be noted that the test vehicle 110 of the illustrated embodiment is a non-limiting example of a test article to be ejected from projectile 108 of FIG. 3A. In further embodiments, any test article can be designed and tested using drop platform 102 and projectile 108 of FIG. 1, including any further vehicles, parachutes, ballistics, propulsion systems, or other aerial components. Furthermore, while test vehicle 110 as shown is configured to obtain dynamic stability data for the capsule shape thereof, test vehicle 110 could be alternatively used for data collection for any other flight performance purposes, without departing from the scope of the present disclosure.

As with projectile 108 of FIG. 3A, a vehicle body 402 of test vehicle 110 can be additively manufactured to provide low-cost, low-weight, custom and quick designs for vehicle body 402. Vehicle body 402 can be shaped to mimic a full-scale capsule to be used on entry/re-entry into Earth's atmosphere to gather data related to deceleration through supersonic regimes and dynamic stability of test vehicle 110. An interior of vehicle body 402 can be partially-hollowed in order to create space for various avionics and electrical components for data gathering during flight and deceleration.

Vehicle body 402 can include a plurality of pressure transducers 404 arranged around a bottom thereof and penetrating towards an exterior surface of vehicle body 402. Pressure transducers 404 can be arranged in a cruciform manner around a bottom of vehicle body 402 to capture data around the full exterior of vehicle body 402. Vehicle body 402 can further include one or more cameras 406 operable to capture a horizon view, an uplook view, or a combination thereof during flight and deceleration. In some embodiments, cameras 406 can obtain photographs at pre-defined intervals during release, flight, and deceleration. In further embodiments, cameras 406 can record video of flight from the moment of ejection from projectile 108 until landing. In some embodiments, cameras 406 can be in communication with a memory card (not shown) for storing the sensor data, such that the memory card can be retrieved upon landing of test vehicle 110 to obtain all stored data.

To further capture flight data related to vehicle performance, vehicle body 402 can further include an inertial measurement unit 408 therein. Inertial measurement unit 408 can include accelerometers, gyroscopes, and magnetometers to determine acceleration, angular velocity, magnetic fields, position, and orientation at all times inclusive of the instrumentation read frequency. In some embodiments, vehicle body 402 can include additional accelerometers, gyroscopes, and magnetometers outside of inertial measurement unit 408, without departing from the scope of the present disclosure. In some embodiments, inertial measurement unit 408 can be in communication with a memory card (not shown) for storing the sensor data, such that the memory card can be retrieved upon landing of test vehicle 110 to obtain all stored data. Each electronic component within vehicle body 402 can be coupled to one or more batteries 410 included within vehicle body 402 to provide power to the measurement system and data recording apparatuses. In some embodiments, test vehicle 110 can include one or more heaters 411 on-board to prevent thermal damage to the sensitive electronics during travel through the atmosphere.

Furthermore, each of pressure transducers 404, cameras 406, inertial measurement unit 408, and battery 410 can be communicatively coupled to a microcontroller 412 installed within vehicle body 402. Microcontroller 412 can control actuation and recording for each sensor within vehicle body 402, and can receive and store any sensor data. In some embodiments, microcontroller 412 can be in communication with a memory card (not shown) for storing the sensor data, such that the memory card can be retrieved upon landing of test vehicle 110 to obtain all stored data. In these embodiments, the memory card can be a high-shock rated memory card and vehicle body 402 can include shock mitigation design considerations to prevent damage to the data stored thereon.

To aid in retrieval of test vehicle 110 after landing, vehicle body 402 can further include one or more transmitters 414 installed therein. Transmitters 414 can include one or both of an ultrahigh-frequency radio transmitter and a global positioning system transmitter in order to broadcast a landing location to an operator. As such, upon landing the operator can utilize signals from transmitters 414 to locate and recover test vehicle 110 and extract flight data therefrom. As such, test vehicle 110 includes a custom, on-board avionics and sensor suite operable to capture rich flight data for test vehicle 110 in supersonic, transonic, and subsonic regimes as it decelerates to terminal velocity.

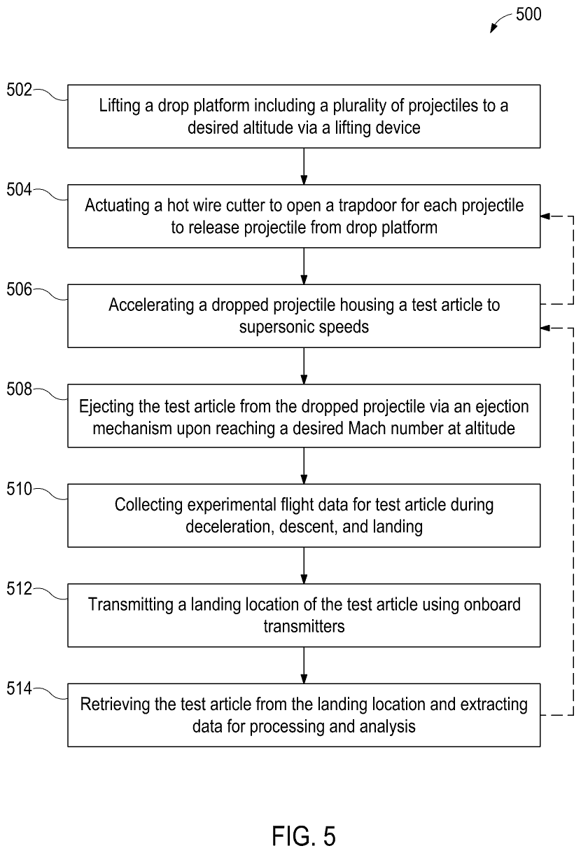

In view of the structural and functional features described above, example methods will be better appreciated with reference to FIG. 5. While, for purposes of simplicity of explanation, the example methods of FIG. 5 are shown and described as executing serially, it is to be understood and appreciated that the present examples are not limited by the illustrated order, as some actions could in other examples occur in different orders, multiple times, and/or concurrently from that shown and described herein. Moreover, it is not necessary that all described actions be performed to implement the methods, and conversely, some actions may be performed that are omitted from the description.

FIG. 5 illustrates an example method 500 for obtaining experimental data of a test vehicle in flight-similar conditions, in accordance with one or more embodiments of the present disclosure. Method 500 may be implemented by multistage flight system 100 of FIG. 1, drop platform 102 of FIG. 2A, projectile 108 of FIG. 3A, and test vehicle 110 of FIG. 4. Thus, reference may be made to the example of FIGS. 1-4 in example method 500 of FIG. 5. Method 500 can begin at 502 with lifting a drop platform (e.g., drop platform 102) to a desired altitude (e.g., target altitude 106) using a lifting device capable of reaching the desired altitude. In some embodiments, the lifting device can be a stratospheric balloon (e.g., balloon 104) operable to lift the drop platform to an altitude of about 40 kilometers above sea level to begin testing. The drop platform can include a plurality of projectiles (e.g., projectiles 108) housed within or supported by respective projectile bays (projectile bays 206) and held in place via trapdoors (e.g., trapdoors 208).

Upon reaching the desired altitude, method 500 can continue at 504 with actuating a hot wire cutter (e.g., trapdoor hot wire cutter mechanism 216) to release the trapdoor for each projectile stored in the drop platform. The trapdoor can be pre-tensioned and held in a closed position via a retention cord, such that the hot wire cutter can release the trapdoor and enable the trapdoor to swing open and out of a drop path of the projectile. In these embodiments, the trapdoor can be fastened to a frame (e.g., frame 202) of the drop platform via a friction hinge (e.g., friction hinge 214) to prevent rebounding of the trapdoor toward the projectile. In some embodiments, platform avionics (e.g., platform avionics 210) can control signaling for each hot wire cutter to drop projectiles at a desired rate. In these embodiments, a subsequent hot wire cutter can be triggered every 30 seconds to facilitate the incremental release of each projectile from the drop platform.

Upon opening of the trapdoor for a projectile, method 500 can continue at 506 with accelerating the dropped projectile to supersonic speeds within the stratosphere. Each projectile can include a test article (e.g., test vehicle 110) therein to be ejected from the projectile upon reaching a desired velocity. As such, each projectile can include an aerodynamic projectile body (e.g., projectile body 302) to enable acceleration up to supersonic speeds prior to release of the test article. As a first dropped projectile accelerates, method 500 can return to 504 with the release of a subsequent projectile after a pre-defined interval has passed. As such, further steps of method 500 can be performed in parallel for each test article stored within projectiles in the drop platform.

For the initial dropped projectile, method 500 can continue at 508 with ejecting the test article from the dropped projectile upon reaching a desired Mach number. In some embodiments, each projectile can include a projectile avionics suite (e.g., projectile avionics 310) therein to monitor accelerations, ambient pressures, heat internal components, and trigger ejection of the test article. The projectile avionics suite can accordingly monitor acceleration of the projectile until the desired Mach number is reached, at which point it can signal an ejection mechanism (e.g., ejection mechanism 316) to release the test article into the freestream. In these embodiments, a hot wire cutter (e.g., ejection hot wire cutter 342) can be actuated to begin severing a retention cord (e.g., retention cord 340) in order to eject the test article. The retention cord can be fixably attached to a travelling plate (e.g., travelling plate 320) of the ejection mechanism, which can be actively compressing a plurality of compression springs (e.g., compression springs 322).

Upon severing the retention cord, the stored energy of the compression springs can be released to translate the travelling plate vertically upwards until reaching a hard stop, thus launching the test article vertically from the projectile. In some embodiments, a custom support claw (e.g., support claw 324) can be provided on the travelling plate to conform to an exterior surface of the test article. In these embodiments, each unique test article can correspond to a matching support claw to enable maximized force transference and linear launching of the test article. The remainder of the projectile and the ejection mechanism can be retained across various test articles and designs, such that only the custom support claw is re-designed and retrofitted to update the projectile for different test articles. This modularity enables various outer mold lines, capsule geometries, vehicle types, and aerial components to be tested using method 500 without ground-up redesigns of the multistage flight system.

In further embodiments, a number of retention tabs (e.g., retention tabs 332) can be released from the test article at 508 to enable release of the test vehicle from the projectile. In these embodiments, each retention tab can be mated to an upper surface of the test article to prevent premature ejection from the projectile, and these retention tabs can be pivoted away from the test article at 508 to provide a clear launching path. In these embodiments, each retention tab can be mated to an interior of the projectile via a hinge (e.g., friction hinge 334) to maintain the retention tabs in open positions after pivoting, thus preventing rebounding of the retention tabs back towards a path of the test article.

Method 500 can continue at 510 with collecting in-flight vehicle state data and other aerodynamic data for the test article during deceleration through the supersonic, transonic, and subsonic regimes as the test article decelerates to terminal velocity. This aerodynamic and vehicle state data can be collected via pressure transducers (e.g., pressure transducers 404), cameras (e.g., camera 406), inertial measurement units (e.g., inertial measurement unit 408), and any other on-board sensors. The data can be collected at 510 through the full deceleration, descent, and landing durations, and the test article can store any sensor readings onto an onboard memory card for later retrieval.

To this end, upon landing of the test article, method 500 can continue at 512 with transmitting a landing location of the test article using one or more onboard transmitters (e.g., transmitters 414). In some embodiments, the transmitters can utilize ultrahigh-frequency radio or global positioning system transmitters to transmit the landing location to an operator. In some embodiments, one or more drones can be deployed in the estimated landing zone to locate and identify the transmissions from the landed test article to identify the landing location. Upon identification of the landing location, method 500 can continue at 514 with retrieving the test article from the landing location and extracting the data (or memory card) for processing and analysis. Method 500 can continue cyclically through steps 506-514 for each projectile and test articles to collect data for numerous test articles in a single launch of the drop platform, until all test articles are recovered.

Using method 500, each test article can be exposed to the Mach number regimes of interest while enabling the test article dynamics to evolve naturally through the supersonic and transonic regimes while gathering real-time data. The similarity to full-scale flight conditions, the richness of the measured data, the controllability, and the repeatability achieved using method 500 can enable the collected data to serve as a standard against which other testing facilities and simulations can be compared and benchmarked. Further, the nested configuration employed by the drop platform, the projectile, and the test article of the method 500 can enable the test article to be introduced to the desired atmospheric conditions at the desired Mach number that would be otherwise unattainable. Additionally, other methods that could deliver the test article to the desired Mach and atmospheric condition can introduce additional complexity in similar test methods, such as extreme vibration, vacuum, shock, and spin environments that can compromise test integrity. Method 500 can accordingly provide high-quality data for a fraction of the cost of traditional testing methods, such as sounding rockets, while enabling multiple launches from a single drop platform and the simultaneous testing of design changes or statistical analysis of a single design launched multiple times.

Embodiments disclosed herein include:
A. A multistage flight system for assessing performance of atmospheric flight systems in high-speed, flight-similar conditions including a drop platform mountable to a lifting device for lifting the drop platform to a target altitude. The drop platform includes a frame sized and shaped to receive one or more payloads, a release mechanism operable to release the one or more payloads from the frame, and platform avionics operable to receive a drop signal and trigger the release mechanism. The system further includes one or more projectiles supported by the frame as the one or more payloads, the one or more projectiles each including an aerodynamic body including a ballast section at a lower end thereof and a plurality of fins at an upper end, an avionics section within the aerodynamic body housing projectile avionics operable to trigger release of a test article stored within the projectile, and an ejection mechanism within the aerodynamic body operable to eject the test article from the projectile when triggered by the projectile avionics.
B. A method of assessing the flight performance of a test vehicle including lifting a drop platform to a desired altitude using a lifting device, the drop platform including a plurality of projectile bays and platform avionics, initiating release of each projectile from each projectile bay at a pre-defined interval upon receiving a drop signal from the lifting device, accelerating a dropped projectile to supersonic, transonic, or subsonic speeds, the dropped projectile housing the test vehicle, ejecting the test vehicle from the dropped projectile using an ejection mechanism of the dropped projectile upon reaching a desired Mach number, a desired target altitude, or a combination thereof, and collecting data for the test vehicle using a plurality of sensors within the test vehicle during deceleration, descent, and landing of the test vehicle.
C. A projectile for accelerating a test article to a desired test condition including an aerodynamic body defining a ballast section at a lower end thereof and a plurality of fins at an upper end, an avionics section within the aerodynamic body and housing projectile avionics operable to trigger release of the test article from the projectile upon reaching the desired test condition, a test article section housing the test article within the aerodynamic body, and an ejection mechanism within the aerodynamic body, the ejection mechanism operable to eject the test article from the projectile when triggered by the projectile avionics.

Each of Embodiments A through C may have one or more of the following additional elements in any combination: Element 1: wherein the test article is a test vehicle, and wherein the test vehicle comprises: a vehicle body including a capsule shape for testing flight performance during atmospheric re-entry; and a plurality of sensors mounted within the vehicle body for collecting flight data for the test vehicle before and after ejection from the projectile. Element 2: wherein the projectile avionics trigger release of the test article upon reaching a target flight condition including a target Mach number, a target altitude, or a combination thereof. Element 3: wherein the frame defines a plurality of projectile bays for receiving and storing a plurality of projectiles within the drop platform. Element 4: wherein the release mechanism is one or more trapdoors installed at a bottom end of the frame and pivotable away from the frame to release each of the one or more projectiles. Element 5: wherein each of the one or more trapdoors is mounted to the frame of the drop platform via a friction hinge to prevent rebounding of each trapdoor. Element 6: wherein the drop platform further comprises one or more trapdoor hot wire cutter mechanisms installed at or near each trapdoor, the trapdoor hot wire cutter mechanisms each operable to sever a retention cord maintaining each trapdoor in a closed position. Element 7: wherein the ejection mechanism of each projectile comprises: one or more compression springs arranged between a travelling plate and a stationary surface; and a support claw actuated by the travelling plate and defining a support surface complementary to an exterior surface of the test article.

Element 8: wherein the ejection mechanism of each projectile further comprises: a retention cord fixably attached to the travelling plate and penetrating through a central aperture of the stationary surface; a gear mechanism mounted to an underside of the stationary surface and receiving the retention cord, the gear mechanism operable to tension the retention cord to translate the travelling plate and compress the one or more compression springs; and an ejection hot wire cutter mounted to an underside of the stationary surface and operable to sever the retention cord to release the travelling plate and eject the test article from the projectile via the support claw. Element 9: further comprising: transmitting a location of the test vehicle after landing using an ultrahigh-frequency radio transmitter, a global positioning system transmitter, or a combination thereof. Element 10: wherein initiating release of each projectile further comprises: transmitting a release signal to a trapdoor hot wire cutter mechanism positioned at or near a trapdoor installed at a bottom of each projectile bay; and severing a retention cord maintaining the trapdoor in a closed position and enabling the trapdoor to swing open. Element 11: further comprising: preventing rebounding of the trapdoor via a friction hinge interposing the trapdoor and a frame of the drop platform. Element 12: wherein ejecting the test vehicle from the dropped projectile further comprises: severing a retention cord maintaining one or more compression springs in a compressed state using an ejection hot wire cutter; and releasing stored energy of the one or more compression springs to translate a travelling plate of the ejection mechanism and a mounted support claw vertically upward to launch the test vehicle from the dropped projectile.

Element 13: further comprising: releasing one or more retention tabs retaining the test vehicle within the dropped projectile via actuation of the ejection mechanism. Element 14: wherein the lifting device is a stratospheric balloon operable to lift the drop platform to an altitude of about 40 kilometers above sea level. Element 15: wherein each projectile houses a unique test vehicle for testing design variations of the test vehicle in a single lifting operation. Element 16: wherein the ejection mechanism comprises: one or more compression springs arranged between a travelling plate and a stationary surface, and a support claw mounted to the travelling plate and defining a support surface complementary to an exterior surface of the test article. Element 17: wherein the ejection mechanism further comprises: a retention cord fixably attached to the travelling plate and penetrating through a central aperture of the stationary surface; a gear mechanism mounted to an underside of the stationary surface and receiving the retention cord, the gear mechanism operable to tension the retention cord to translate the travelling plate and compress the one or more compression springs; and an ejection hot wire cutter mounted to an underside of the stationary surface and operable to sever the retention cord to release the travelling plate and eject the test article from the projectile via the support claw.

By way of non-limiting example, exemplary combinations applicable to A through C include: Element 4 with Element 5; Element 5 with Element 6; Element 7 with Element 8; Element 10 with Element 11; Element 12 with Element 13; Element 14 with Element 15; and Element 16 with Element 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A multistage flight system for assessing performance of atmospheric flight systems in high-speed, flight-similar conditions, the system comprising:
a drop platform mountable to a lifting device for lifting the drop platform to a target altitude, the drop platform including:
a frame sized and shaped to receive one or more payloads,
a release mechanism operable to release the one or more payloads from the frame, and
platform avionics operable to receive a drop signal and trigger the release mechanism; and
one or more projectiles supported by the frame as the one or more payloads, the one or more projectiles each including:
an aerodynamic body including a ballast section at a lower end thereof and a plurality of fins at an upper end,
an avionics section within the aerodynamic body housing projectile avionics operable to trigger release of a test article stored within the projectile, and
an ejection mechanism within the aerodynamic body operable to eject the test article from the projectile when triggered by the projectile avionics.

2. The multistage flight system of claim 1, wherein the test article is a test vehicle, and wherein the test vehicle comprises:
a vehicle body including a capsule shape for testing flight performance during atmospheric re-entry; and
a plurality of sensors mounted within the vehicle body for collecting flight data for the test vehicle before and after ejection from the projectile.

3. The multistage flight system of claim 1, wherein the projectile avionics trigger release of the test article upon reaching a target flight condition including a target Mach number, a target altitude, or a combination thereof.

4. The multistage flight system of claim 1, wherein the frame defines a plurality of projectile bays for receiving and storing a plurality of projectiles within the drop platform.

5. The multistage flight system of claim 1, wherein the release mechanism is one or more trapdoors installed at a bottom end of the frame and pivotable away from the frame to release each of the one or more projectiles.

6. The multistage flight system of claim 5, wherein each of the one or more trapdoors is mounted to the frame of the drop platform via a friction hinge to prevent rebounding of each trapdoor.

7. The multistage flight system of claim 6, wherein the drop platform further comprises one or more trapdoor hot wire cutter mechanisms installed at or near each trapdoor, the trapdoor hot wire cutter mechanisms each operable to sever a retention cord maintaining each trapdoor in a closed position.

8. The multistage flight system of claim 1, wherein the ejection mechanism of each projectile comprises:
one or more compression springs arranged between a travelling plate and a stationary surface; and
a support claw actuated by the travelling plate and defining a support surface complementary to an exterior surface of the test article.

9. The multistage flight system of claim 8, wherein the ejection mechanism of each projectile further comprises:
a retention cord fixably attached to the travelling plate and penetrating through a central aperture of the stationary surface;
a gear mechanism mounted to an underside of the stationary surface and receiving the retention cord, the gear mechanism operable to tension the retention cord to translate the travelling plate and compress the one or more compression springs; and
an ejection hot wire cutter mounted to an underside of the stationary surface and operable to sever the retention cord to release the travelling plate and eject the test article from the projectile via the support claw.

10. A method of assessing the flight performance of a test vehicle, the method comprising:
lifting a drop platform to a desired altitude using a lifting device, the drop platform including a plurality of projectile bays and platform avionics;
initiating release of each projectile from each projectile bay at a pre-defined interval upon receiving a drop signal from the lifting device;
accelerating a dropped projectile to supersonic, transonic, or subsonic speeds, the dropped projectile housing the test vehicle;
ejecting the test vehicle from the dropped projectile using an ejection mechanism of the dropped projectile upon reaching a desired Mach number, a desired target altitude, or a combination thereof; and
collecting data for the test vehicle using a plurality of sensors within the test vehicle during deceleration, descent, and landing of the test vehicle.

11. The method of claim 10, further comprising:
transmitting a location of the test vehicle after landing using an ultrahigh-frequency radio transmitter, a global positioning system transmitter, or a combination thereof.

12. The method of claim 10, wherein initiating release of each projectile further comprises:
transmitting a release signal to a trapdoor hot wire cutter mechanism positioned at or near a trapdoor installed at a bottom of each projectile bay; and
severing a retention cord maintaining the trapdoor in a closed position and enabling the trapdoor to swing open.

13. The method of claim 12, further comprising:
preventing rebounding of the trapdoor via a friction hinge interposing the trapdoor and a frame of the drop platform.

14. The method of claim 10, wherein ejecting the test vehicle from the dropped projectile further comprises:
severing a retention cord maintaining one or more compression springs in a compressed state using an ejection hot wire cutter; and
releasing stored energy of the one or more compression springs to translate a travelling plate of the ejection mechanism and a mounted support claw vertically upward to launch the test vehicle from the dropped projectile.

15. The method of claim 14, further comprising:
releasing one or more retention tabs retaining the test vehicle within the dropped projectile via actuation of the ejection mechanism.

16. The method of claim 10, wherein the lifting device is a stratospheric balloon operable to lift the drop platform to an altitude of about 40 kilometers above sea level.

17. The method of claim 16, wherein each projectile houses a unique test vehicle for testing design variations of the test vehicle in a single lifting operation.

18. A projectile for accelerating a test article to a desired test condition, the projectile comprising:
an aerodynamic body defining a ballast section at a lower end thereof and a plurality of fins at an upper end;
an avionics section within the aerodynamic body and housing projectile avionics operable to trigger release of the test article from the projectile upon reaching the desired test condition;
a test article section housing the test article within the aerodynamic body; and
an ejection mechanism within the aerodynamic body, the ejection mechanism operable to eject the test article from the projectile when triggered by the projectile avionics.

19. The projectile of claim 18, wherein the ejection mechanism comprises:
one or more compression springs arranged between a travelling plate and a stationary surface, and
a support claw mounted to the travelling plate and defining a support surface complementary to an exterior surface of the test article.

20. The projectile of claim 19, wherein the ejection mechanism further comprises:
a retention cord fixably attached to the travelling plate and penetrating through a central aperture of the stationary surface;
a gear mechanism mounted to an underside of the stationary surface and receiving the retention cord, the gear mechanism operable to tension the retention cord to translate the travelling plate and compress the one or more compression springs; and
an ejection hot wire cutter mounted to an underside of the stationary surface and operable to sever the retention cord to release the travelling plate and eject the test article from the projectile via the support claw.
